(19) United States
(12) Patent Application Publication
(10) Pub. No.: US 2008/0249340 A1
(43) Pub. Date: Oct. 9, 2008

(54) Hydro-Oxidation of Hydrocarbons Using a Catalyst Prepared by Microwave Heating

(76) Inventors: Susan J. Siler, Lake Jackson, TX (US); Joseph D. Henry, Lake Jackson, TX (US)

Correspondence Address: The Dow Chemical Company, Intellectual Property Section, P.O. Box 1967, Midland, MI, 48641-1967, US

(21) Appl. No.: 11/547,060

(22) PCT Filed: Mar. 4, 2005
(86) PCT No.: PCT/US05/07528

§ 371 Date: Sep. 28, 2006

Related U.S. Application Data
(60) Provisional application No. 60/558,649, filed on Apr. 1, 2004.

(51) Int. Cl. B01J 37/34; C07B 41/00; B01J 21/06; B01J 27/06; B01J 27/14; B01J 27/232; B01J 29/06; B01J 31/26

(52) U.S. Cl. 568/952; 502/5; 502/242; 502/227; 502/214; 502/174; 502/150; 502/73; 502/74; 502/77

(57) ABSTRACT

A process and hydro-oxidation catalyst for the hydro-oxidation of a hydrocarbon, preferably a C₃₋₈ olefin, such as propylene, by oxigen in the presence of hydrogen to the corresponding partially-oxidized hydrocarbon, preferably, a C₃₋₈ olefin oxide, preferably, propylene oxide. The catalyst comprises gold, silver, one or more platinum group metals, one or more lanthanide rare earth metals, or a mixture thereof, deposited on a titanosilicate, preferably TS-1 characterized in that titanosilicate is prepared by microwave heating.

### CROSS REFERENCE STATEMENT

This application claims the benefit of U.S. Provisional Application No. 60/558,649, filed Apr. 1, 2004.

### BACKGROUND OF THE INVENTION

This invention pertains to a process and catalyst for the hydro-oxidation of a hydrocarbon, such as an olefin, by oxygen in the presence of hydrogen to form a partially-oxidized hydrocarbon, such as an olefin oxide.

Partially-oxidized hydrocarbons, for example, olefin oxides, alcohols, ketones, and carboxylic acids, find a multitude of utilities. Olefin oxides, such as propylene oxide, are used to alkoxylate alcohols to form polyether polyols, such as polypropylene polyether polyols, which find utility in the manufacture of polyurethanes and synthetic elastomers. Olefin oxides are also important intermediates in the manufacture of alkylene glycols, such as propylene glycol, and alkanolamines, such as isopropanolamine, which find utility as solvents and surfactants. Alcohols and ketones find utility as solvents and in organic syntheses. Carboxylic acids find utility in the manufacture of esters and production of plastics.

“Hydro-oxidation processes,” as the term is used herein, pertain to the oxidation of hydrocarbons directly with oxygen in the presence of a material amount of hydrogen and in the presence of a hydro-oxidation catalyst. The products of these processes comprise “partially-oxidized hydrocarbons,” which for the purposes of this invention comprise carbon, hydrogen, and oxygen. Olefins, for example, can be hydro-oxidized with oxygen in the presence of hydrogen and a hydro-oxidation catalyst to form olefin oxides. Alkanes can be hydro-oxidized to form alcohols, ketones, and carboxylic acids.

Hydro-oxidation processes have received considerable attention in recent years, because the partially-oxidized products of these processes are formed in high selectivity. Olefin oxides, for example, can be obtained in greater than 90 mole percent selectivity. Undesirable deep oxidation products, such as carbon monoxide and carbon dioxide, are usually formed in significantly lower selectivity. Hydro-oxidation processes provide a distinct advantage over direct oxidation processes wherein an olefin is oxidized directly with oxygen in the absence of a material amount of hydrogen, typically, for example, in air, to form an olefin oxide. In direct oxidation, olefin oxides are formed in a selectivity of only about 60-70 mole percent. Representative art disclosing hydro-oxidation processes can be found in the following patent publications: EP-A1-0,709,360, WO-A1-96/02323, WO 98/00413, WO 98/00414, WO 98/00415, WO 99/00188, WO 00/35893, WO 00/59632, DE-A1-19600709, and WO 97/25143.

Hydro-oxidation processes employ catalysts comprising one or more catalytic metals, typically, selected from gold, silver, the platinum group metals, the lanthanide rare earth metals, and mixtures thereof, deposited on a titanosilicate, preferably, of the MFI or MEL crystallographic structure. Generally, the catalytic metals are deposited on the titanosilicate by impregnation, as described in WO 00/59633, or by deposition-precipitation, as described in U.S. Pat. No. 4,839,327 and U.S. Pat. No. 4,937,219. Typically, the titanosilicate is synthesized using conventional hydro-thermal methods, as described in U.S. Pat. No. 4,778,666 and WO 01/64581. The hydro-thermal syntheses require crystallization times ranging from about 1 to about 7 days or longer; thus, the synthesis of the titanosilicate impedes efficient preparation of the hydro-oxidation catalyst and consequential commercial activity.

In view of the above, it would be desirable to prepare a hydro-oxidation catalyst efficiently, that is, without the need for time-consuming hydro-thermal crystallizations of the titanosilicate. It would be even more desirable if the microwave-prepared hydro-oxidation catalyst could exhibit comparable or better performance, such as better activity, selectivity, hydrogen efficiency, and/or lifetime, in hydro-oxidation processes, as compared with present day hydro-oxidation catalysts prepared by hydro-thermal methods.

The prior art teaches the efficient preparation of titanosilicates by microwave heating, as illustrated by the following references: W. S. Ahn et al., Studies in Surface Science Catalysis, 55 (2001), 104-111; A. Belhekar et al., Bulletin of the Chemical Society of Japan, 73 (2000), 2605-2608; K. K. Kang et al., Catalysis Letters, 59 (1999), 45-49; P. J. Kooyman et al., Journal of Molecular Catalysis A, Chemical 111 (1996), 167-174; and M. R. Prasad et al., Catalysis Communications, 3 (2002), 399-404. Certain of these references teach the use of microwave-synthesized titanosilicates in the liquid phase oxidation of alkanes or aromatic compounds with hydrogen peroxide as an oxidant. None of the aforementioned references discloses or suggests that a titanosilicate prepared by microwave heating could be suitably employed to prepare a hydro-oxidation catalyst for an oxidation with oxygen in the presence of hydrogen.

### SUMMARY OF THE INVENTION

In one aspect, this invention provides for a novel hydro-oxidation process comprising contacting a hydrocarbon with oxygen in the presence of hydrogen and in the presence of a hydro-oxidation catalyst under process conditions sufficient to produce a partially-oxidized hydrocarbon. In a novel aspect, the unique catalyst that is employed in the process of this invention comprises one or more catalytic metals selected from gold, silver, the platinum group metals, the lanthanide rare earth metals, and mixtures thereof, deposited on a titanosilicate, characterized in that the titanosilicate is prepared by microwave heating.

The novel process of this invention is useful for producing partially-oxidized hydrocarbons, such as olefin oxides, alcohols, ketones, and carboxylic acids, directly from a hydrocarbon and oxygen in the presence of hydrogen. For the purposes of this invention, partially-oxidized hydrocarbons comprise carbon, hydrogen, and oxygen. The novel process of this invention employs a catalyst comprising, as one component, a titanosilicate prepared by microwave heating. Advantageously, microwave heating expedites the formation of the titanosilicate within a few hours. In contrast, from about 1 to about 7 days or longer are required to prepare titanosilicates with good yields by conventional hydro-thermal methods. Unexpectedly, the hydro-oxidation catalyst of this invention, employing a titanosilicate prepared by microwave heating, exhibits improved performance in hydro-oxidation processes, as compared with hydro-oxidation catalysts having a titanosilicate prepared by conventional hydro-thermal methods.

In another aspect, this invention is a unique catalyst composition comprising one or more catalytic metals selected from gold, silver, the platinum group metals, the lanthanide rare earth metals, and mixtures thereof, deposited on a titanosilicate, characterized in that the titanosilicate is prepared by microwave heating.

Beneficially, the novel hydro-oxidation catalyst of this invention can be prepared in a commercially acceptable time period of just a few hours. In this regard, the catalyst of this invention is advantaged over prior art hydro-oxidation catalysts, which require many days for preparation of the titanosilicate component. Moreover, the catalyst of this invention, whose titanosilicate component is prepared by microwave heating, achieves improved performance, in the form of improved activity and high selectivity, as compared with prior art hydro-oxidation catalysts whose titanosilicate component is prepared by conventional hydro-thermal methods.

In yet another aspect, this invention provides for a novel method of preparing a hydro-oxidation catalyst comprising (a) heating by microwave radiation a synthesis solution comprising a source of titanium, a source of silicon, a structure directing agent (or template), and water, under conditions sufficient to prepare a titanosilicate; (b) recovering the titanosilicate from the synthesis solution, and calcining the titanosilicate to remove the structure directing agent (or template); (c) depositing a catalytic metal onto the calcined titanosilicate, the catalytic metal being selected from gold, silver, one or more platinum group metals, one or more lanthanide rare earth metals, and mixtures thereof, to form a metal-titanosilicate composite; and optionally (d) heating the metal-titanosilicate composite under an oxygen-containing gas or under a reducing atmosphere or under an inert gas, under conditions sufficient to prepare the hydro-oxidation catalyst.

The aforementioned method of preparing a hydro-oxidation catalyst advantageously reduces preparation time as compared with prior art methods. Moreover, the catalyst produced exhibits improved performance in hydro-oxidation processes for preparing partially-oxidized hydrocarbons.

### DRAWINGS

FIG. 1 depicts a synthesis reaction process for preparing a titanosilicate with crystallization by microwave radiation.

FIG. 2 depicts a continuous synthesis reaction process for preparing a titanosilicate with crystallization by microwave radiation.

### DETAILED DESCRIPTION OF THE INVENTION

The invention described herein provides, in one aspect, for a novel hydro-oxidation process to prepare a partially-oxidized hydrocarbon. The process comprises contacting a hydrocarbon with oxygen in the presence of hydrogen and a hydro-oxidation catalyst, the catalyst comprising one or more catalytic metals selected from gold, silver, the platinum group metals, the lanthanide rare earth metals, and mixtures thereof, deposited on a titanosilicate, wherein the contacting is conducted under process conditions sufficient to prepare the partially-oxidized hydrocarbon. In a novel aspect of this invention, the titanosilicate is characterized as being prepared by microwave heating.

In a preferred embodiment of this invention, the hydrocarbon to be oxidized is an olefin, more preferably, a C₃₋₁₂ olefin. In an even more preferred embodiment, the olefin is a C₃₋₈ olefin, and it is converted to the corresponding C₃₋₈ olefin oxide. In a most preferred embodiment, the olefin is propylene, and it is converted to propylene oxide.

The novel catalyst which is employed in the hydro-oxidation process of this invention comprises one or more metals selected from gold, silver, the platinum group metals, the lanthanide rare earth metals, and mixtures thereof, deposited on a titanosilicate, the titanosilicate characterized in that it is prepared by microwave heating. In a preferred embodiment, the catalytic metal is gold, optionally in combination with silver, one or more platinum group metals, one or more lanthanide rare earth metals, or a mixture thereof Preferably, the titanosilicate is crystalline, as determined by X-ray diffraction (XRD). More preferably, the titanosilicate is a porous crystalline titanosilicate, characterized by a network of pores or channels or cavities within its crystalline framework structure. A most preferred form of the titanosilicate comprises an MFI crystallographic structure, such as, titanium silicalite-1 (TS-1).

In yet another aspect, this invention provides for a novel method of preparing a hydro-oxidation catalyst comprising (a) heating by microwave radiation a synthesis solution comprising a source of titanium, a source of silica, a structure directing agent (or template), preferably in the form of an amine or a quaternary ammonium compound, and water, under conditions sufficient to prepare a titanosilicate; (b) recovering the titanosilicate from the synthesis solution, and calcining the thus-formed titanosilicate to remove the structure directing agent (or template); (c) depositing a catalytic metal onto the titanosilicate, the catalytic metal being selected from gold, silver, one or more platinum group metals, one or more lanthanide rare earth metals, and mixtures thereof to form a metal-titanosilicate composite; and optionally (d) heating the metal-titanosilicate composite under an oxygen-containing gas or under a reducing atmosphere or under an inert gas, under conditions sufficient to prepare the hydro-oxidation catalyst.

In a preferred embodiment of the catalyst preparation, the synthesis solution is comprised of tetraethylorthosilicate (TEOS), titanium tetra(n-butoxide), tetrapropylammonium hydroxide (TPAOH) as a structure-directing agent, and water. In another preferred embodiment, the synthesis solution comprises on a molar basis: a SiO₂/TiO₂ ratio in the range of about 5 to about 20,000, a ratio of SiO₂ to structure directing agent in the range of about 1.7 to about 8.3, and a SiO₂/H₂O ratio in the range of about 0.005 to about 0.49. In a more preferred embodiment, the synthesis solution comprises, on a molar basis, a SiO₂/TiO₂ ratio in the range of about 35 to about 1000, a ratio of silica to structure-directing agent in the range of about 2.08 to about 6.25, and a SiO₂/H₂O ratio in the range of about 0.070 to about 0.028. The aforementioned synthesis solution is in a preferred embodiment heated by microwave radiation under the following conditions: energy input, from greater than about 100 to less than about 6,000 watts per liter synthesis solution, heated at a rate of greater than about 0.5° C./min to less than about 40° C./min to a predetermined final temperature; and then heated at the final temperature of greater than about 140° C. and less than about 250° C. for a time ranging from greater than about 3 minutes to less than about 16 hours. Under the aforementioned conditions, in a most preferred embodiment, the titanosilicate produced comprises a MFI structure TS-1. In another preferred embodiment, the catalytic metal deposited on the titanosilicate comprises gold.

The hydrocarbon can be any hydrocarbon capable of participating in such a hydro-oxidation process, preferably, an alkane or an olefin. Typical alkanes comprise from 1 to about 20 carbon atoms, and preferably from 1 to about 12 carbon atoms. Typical olefins comprise from 2 to about 20 carbon atoms, preferably, from 2 to about 12 carbon atoms. Among the olefins, monoolefins are preferred, but olefins containing two or more double bonds, such as dienes, can also be employed. The hydrocarbon can contain only carbon and hydrogen atoms, or optionally, can be substituted at any of the carbon atoms with an inert substituent. The term “inert”, as used herein, requires the substituent to be substantially non-reactive in the process of this invention. Suitable inert substituents include, but are not limited to halo, ether, ester, alcohol, and aromatic moieties. Preferably, the halo substituent is chloro. Preferably, the ether, ester, and alcohol moieties comprise from 1 to about 12 carbon atoms. Preferably, the aromatic moiety comprises from about 6 to about 12 carbon atoms. Non-limiting examples of olefins suitable for the process of this invention include ethylene, propylene, 1-butene, 2-butene, 2-methylpropene, 1-pentene, 2-pentene, 2-methyl-1-butene, 2-methyl-2-butene, 1-hexene, 2-hexene, 3-hexene, and analogously, the various isomers of methylpentene, ethylbutene, heptene, methylhexene, ethylpentene, propylbutene, the octenes, including preferably 1-octene, and other higher analogues of these; as well as butadiene, cyclopentadiene, dicyclopentadiene, styrene, α-methylstyrene, divinylbenzene, allyl chloride, allyl alcohol, allyl ether, allyl ethyl ether, allyl butyrate, allyl acetate, allyl benzene, allyl phenyl ether, ally propyl ether, and allyl anisole. Preferably, the olefin is an unsubstituted or substituted C₃₋₁₂ olefin, more preferably, an unsubstituted or substituted C₃₋₈ olefin, most preferably, propylene.

The quantity of hydrocarbon employed in the hydro-oxidation process can vary over a wide range. Typically, the quantity of hydrocarbon is greater than about 1, more preferably, greater than about 10, and most preferably, greater than about 20 mole percent, based on the total moles of hydrocarbon, oxygen, hydrogen, and any optional diluent that may be used, as noted hereinafter. Typically, the quantity of hydrocarbon is less than about 99, more preferably, less than about 85, and most preferably, less than about 70 mole percent, based on the total moles of hydrocarbon, oxygen, hydrogen, and optional diluent.

Oxygen is required for the process of this invention. Any source of oxygen is acceptable, with air and essentially pure molecular oxygen being preferred. The quantity of oxygen employed can also vary over a wide range. Preferably, the quantity of oxygen is greater than about 0.01, more preferably, greater than about 1, and most preferably greater than about 5 mole percent, based on the total moles of hydrocarbon, hydrogen, oxygen, and optional diluent. Preferably, the quantity of oxygen is less than about 30, more preferably, less than about 20, and most preferably less than about 15 mole percent, based on the total moles of hydrocarbon, hydrogen, oxygen, and optional diluent.

Hydrogen is also required for the process of this invention, any source of which may be suitably employed. The amount of hydrogen employed can be any material amount capable of effecting hydro-oxidation. Typically, the amount of hydrogen employed is greater than about 0.01, preferably, greater than about 0.1, and more preferably, greater than about 1 mole percent, based on the total moles of hydrocarbon, hydrogen, oxygen, and optional diluent. Suitable quantities of hydrogen are typically less than about 50, preferably, less than about 30, and more preferably, less than about 15 mole percent, based on the total moles of hydrocarbon, hydrogen, oxygen, and optional diluent.

In addition to the above reactants, it may be desirable to employ a diluent. Since the process is exothermic, a diluent beneficially provides a means of removing and dissipating heat produced. In addition the diluent provides an expanded concentration regime over which the reactants are non-flammable. The diluent can be any gas or liquid that does not inhibit the process of this invention. If the process is conducted in a gas phase, then suitable gaseous diluents include, but are not limited to helium, nitrogen, argon, methane, propane, carbon dioxide, steam, and mixtures thereof. If the process is conducted in a liquid phase, then the diluent can be any oxidation stable and thermally stable liquid. Examples of suitable liquid diluents include aliphatic alcohols, preferably C₁₋₁₀ aliphatic alcohols, such as methanol and t-butanol; chlorinated aliphatic alcohols, preferably C₁₋₁₀ chlorinated alkanols, such as chloropropanol; chlorinated aromatics, preferably chlorinated benzenes, such as chlorobenzene and dichlorobenzene; as well as liquid polyethers, polyesters, and polyalcohols. If used, the amount of diluent is typically greater than about 0, preferably greater than about 0.1, and more preferably, greater than about 15 mole percent, based on the total moles of hydrocarbon, oxygen, hydrogen, and diluent. The amount of diluent is typically less than about 95, preferably, less than about 85, and more preferably, less than about 50 mole percent, based on the total moles of hydrocarbon, oxygen, hydrogen, and diluent.

The unique catalyst which is beneficially employed in the process of this invention comprises one or more catalytic metals deposited on a titanosilicate, the metals being selected from gold, silver, the platinum group metals, the lanthanide rare earth metals, and mixtures thereof. For the purposes of this invention, the platinum group metals include ruthenium, rhodium, palladium, platinum, osmium, and iridium; and the lanthanide metals include lanthanum, cerium, praseodymium, neodymium, promethium, samarium, europium, gadolinium, terbium, dysprosium, holmium, erbium, thulium, ytterbium, and lutetium. Preferably, the platinum group metal is palladium. Preferably, the lanthanide rare earth metal is selected from erbium and lutetium. More preferably, the catalytic metal comprises gold or a combination of gold with silver, one or more platinum group metals, one or more lanthanide rare earth metals, or a mixture thereof.

Generally, the titanosilicate comprises a crystalline, quasi-crystalline, or amorphous framework formed from SiO₄⁴⁻ tetrahedra wherein a portion of the silicon atoms is replaced with titanium atoms, providing nominally for TiO₄⁴⁻ tetrahedra. Preferably, the titanosilicate is crystalline, which implies that the framework has a periodic regularity which is identifiable by X-ray diffraction (XRD). Preferably, the titanosilicate is also porous, which means that within the titanosilicate framework there exists a regular or irregular system of pores or channels. Preferably, the pores are micropores or mesopores or some combination thereof. For the purposes of this invention, a micropore is characterized by a pore diameter (or critical dimension as in the case of a non-circular perpendicular cross-section) ranging from about 4 Å to about 20 Å; and a mesopore is characterized by a pore diameter (or critical dimension) ranging from greater than 20 Å to less than about 200 Å. The combined volume of micropores and mesopores preferably comprises greater than about 70 percent of the total pore volume, and preferably, greater than about 80 percent of the total pore volume. The balance of the pore volume comprises macropores having a pore diameter of greater than about 200 Å. Non-limiting examples of suitable titanosilicates include titanium silicalite-1 (TS-1), titanium silicalite-2 (TS-2), titanosilicate beta (Ti-beta), titanosilicate ZSM-5 (Ti-ZSM-5), titanosilicate ZSM-12 (Ti-ZSM-12), titanosilicate ZSM-48 (Ti-ZSM-48), and mesoporous titanosilicates, such as titanosilicate MCM-41 (Ti-MCM-41), and likewise Ti-MCM-48 and the SMA family. The silicon to titanium atomic ratio (Si/Ti) of the titanosilicate can be any that provides for an active and selective hydro-oxidation catalyst. A generally advantageous Si/Ti atomic ratio is equal to or greater than about 5/1, and preferably, equal to or greater than about 10/1, preferably, greater than about 35/1, and more preferably, greater than about 50/1. A generally advantageous Si/Ti atomic ratio is equal to or less than about 20,000/1, preferably, less than about 10,000/1, more preferably, less than about 1,000/1, and most preferably, less than about 300/1. The Si/Ti atomic ratio defined hereinabove refers to a bulk ratio that includes the total of the framework titanium and any extra-framework titanium that may be present.

The preparation of the aforementioned titanosilicate comprises heating by microwave radiation a synthesis solution containing a source of titanium and a source of silicon, under conditions sufficient to prepare the titanosilicate. Typically, the synthesis solution comprises a source of titanium, a source of silicon, water, and a template or structure directing agent, such as, an amine or a tetraalkylammonium hydroxide. Suitable synthesis solutions can be found in the conventional hydro-thermal art on titanosilicates, reference being made to the preparation of TS-1, which is described in U.S. Pat. No. 4,410,501 and U.S. Pat. No. 6,255,499 B1, incorporated herein by reference. Non-limiting examples of suitable sources of titanium include any hydrolysable titanium compound, chosen preferably from titanium tetra(alkoxides), more preferably titanium tetra(ethoxide), titanium tetra(isopropoxide), titanium tetra(n-butoxide); and titanium tetrahalides, preferably, titanium tetrafluoride or titanium tetrachloride; and titanium oxyhalides, such as titanium oxychloride. Preferably, the source of titanium is titanium tetra(n-butoxide). Non-limiting examples of suitable sources of silicon include tetraalkylorthosilicates, such as tetraethylorthosilicate, or fumed or precipitated silicas, but preferably, a silica not containing sodium ions. Preferably, the source of silicon is tetraethylorthosilicate. Non-limiting examples of suitable templates or structure directing agents include trialkylamines and quaternary ammonium compounds. The trialkylamines are preferably a tri(C₁₋₁₅ alkyl) amine, such as triethylamine, tripropylamine, and tri(n-butyl)amine. The quaternary ammonium compounds can be tetraalkylammonium hydroxides or tetraalkylammonium halides, such as tetra(ethyl)ammonium hydroxide, tetra(propyl)ammonium hydroxide, tetra(n-butyl)ammonium hydroxide, and the corresponding halides. Preferably, the structure directing agent (or template) is tetrapropylammonium hydroxide (TPAOH).

The relative quantities of source of titanium, source of silicon, template or structure-directing agent, and water will vary depending upon the specific titanosilicate to be synthesized. Guidance can be found in the conventional art. A preferred synthesis solution comprises the following general composition, presented on a molar basis: a SiO₂/TiO₂ ratio in the range of about 5 to about 20,000, a ratio of SiO₂ to structure directing agent in the range of about 1.7 to about 8.3, and a SiO₂/H₂O ratio in the range of about 0.005 to about 0.49. In a more preferred embodiment, the synthesis solution comprises, on a molar basis, a SiO₂/TiO₂ ratio in the range of about 35 to about 1000, a ratio of SiO₂ to structure directing agent in the range of about 2.08 to about 6.25, and a SiO₂/H₂O ratio in the range of about 0.070 to about 0.028. Typically, the most preferred synthesis solution produces a titanosilicate having a Si/Ti atomic ratio greater than about 50/1 and less than about 300/1.

The microwave radiation generator, power input, and crystallization conditions can vary, provided that such generator and crystallization conditions produce a titanosilicate product in an acceptable time period, typically less than about 16 hours. Any commercially available microwave generator may be employed, such as, an Ethos 900 Plus Microwave Digestion System, which offers a programmable program of variable energy input to maintain a desired temperature profile. Preferably, a power input ranging from about 100 to about 6,000 watts, or higher, per liter of synthesis solution; more preferably, from about 100 to about 1,500 watts per liter of synthesis solution; and most preferably, from about 200 to about 600 watts per liter of synthesis solution, provides for a suitable preparation condition. Generally, the heating rate is greater than about 0.5° C./min, preferably, greater than about 5° C./min, and more preferably, greater than about 8° C./min. Generally, the heating rate is less than about 40° C./min, preferably, less than about 25° C./min, and more preferably, less than about 15° C./min. Typically, the temperature of the synthesis solution is ramped up from room temperature to a final temperature for a final hold time, optionally, with one intermediate stop at a first temperature for a first hold time. After the final hold time, the temperature is slowly returned to room temperature for recovery of product. Based on this scheme, if a first temperature is employed, then the first temperature is typically greater than about 80° C., preferably, greater than about 95° C., and more preferably, greater than about 100° C. Typically, the first temperature is less than about 150° C., preferably, less than about 125° C., and more preferably, less than about 110° C. The first temperature hold time, if used, is typically greater than about 0 min, and preferably, greater than about 10 min. The first temperature hold time is typically less than about 120 min and preferably less than about 60 min. Preferably, the temperature is simply ramped to a final temperature without the intermediate stop at a first heating temperature. Generally, the final temperature is greater than about 140° C., preferably, greater than about 150° C., and more preferably, greater than about 160° C. Generally, the final temperature is less than about 250° C., preferably less than about 210° C., more preferably, less than about 200° C., and most preferably, less than about 190° C. The final temperature hold time is typically greater than about 3 minutes, preferably, greater than about 30 min, more preferably, greater than about 60 min, and most preferably, greater than about 120 min. The final temperature hold time is typically less than about 960 min (16 hr), and preferably, less than about 480 min (8 hr).

Recovery of the titanosilicate product may be effected by any method known in the art including, but not limited to, filtration, centrifugation, or flocculation followed by filtration or centrifugation. If filtration is used, then typically a filter greater than about 0.05 microns but less than about of 0.5 is beneficially employed to collect the product. Alternatively, the synthesis mixture may be ultra-centrifuged to yield a solid, which may be rinsed and dried, for example, freeze dried, to obtain the titanosilicate product. In a third recovery method, the synthesis mixture may be centrifuged and the liquor obtained from the centrifugation may then be heated at a temperature between about 50° C. and about 110° C. to rid the liquor of volatile compounds, such as alcohol or amine. Thereafter, the pH of the synthesis solution is adjusted with any appropriate inorganic or organic acid or base to a value greater than about 5, and preferably, greater than about 7, but less than about 10, preferably, less than about 9, and more preferably, less than about 8.5, to obtain a precipitate, after which filtration or centrifugation is effected to collect the titanosilicate. In a fourth recovery method, the synthesis solution can be treated with inorganic acid to adjust the pH to between about 7 and about 9; and thereafter, the acid-treated mixture may be filtered or centrifuged to collect the titanosilicate product. A fifth recovery method involves centrifuging the synthesis mixture to collect a crystalline solid, which is thereafter washed with acid, for example, 0.01 M to 5.0 M nitric acid or hydrochloric acid. The washing can be repeated and is generally conducted at a temperature between about 23° C. and about 90° C.

The solid product collected by any of the aforementioned recovery methods is typically dried at a temperature between about ambient, taken as about 20° C., and about 110° C. Thereafter, the dried product is calcined to remove the structure directing agent (or template) from the titanosilicate product. The calcination is conducted typically in an atmosphere of nitrogen containing from about 0 to about 30 percent oxygen, and preferably, from about 10 to about 25 percent oxygen, by volume. The calcination temperature beneficially is greater than about 450° C., preferably, greater than about 500° C., and more preferably greater than about 525° C. The calcination temperature beneficially is less than about 900° C., preferably, less than about 750° C., and more preferably, less than about 600° C. The heating rate from room temperature to the calcination temperature is typically greater than about 0.1° C./min, and preferably, greater than about 0.5° C./min, and more preferably, greater than about 1.5° C./min. The heating rate from room temperature to the calcination temperature is typically less than about 20° C./min, preferably, less than about 15° C./min, and more preferably, less than about 10° C./min. At the calcination temperature, the hold time is typically greater than about 2, preferably greater than about 5, and more preferably, greater than about 8 hours; while the hold time is typically less than about 15, and preferably, less than about 12 hours.

The titanosilicate product isolated from the above synthesis typically is crystalline, or at least quasi-crystalline, and preferably, possesses a MFI TS-1 crystallographic structure, as determined by X-Ray diffraction. Crystal size depends upon the crystallization conditions. For those crystallization conditions mentioned hereinabove, the average crystal size is typically larger than about 0.01 micron, and preferably, larger than about 0.1 micron in diameter (or critical cross-sectional dimension for non-spherical particles). The average crystal size is typically smaller than about 5 microns, and preferably, smaller than about 2 microns.

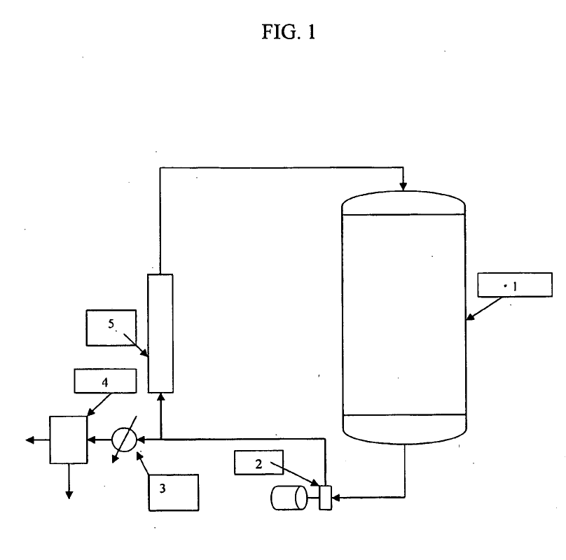

With reference to FIG. 1, a synthesis reaction process is envisioned for manufacturing the titanosilicate using microwave radiation crystallization. In the illustrated embodiment a reactor vessel (FIG. 1, unit 1) is loaded with a synthesis reaction mixture comprising water, a source of titanium, a source of silicon, and a structure directing agent or template. The synthesis reaction mixture is circulated between the reactor vessel (FIG. 1, unit 1) and a microwave source unit (FIG. 1, unit 5) via pump unit (FIG. 1, unit 2) and connecting conduits. After an appropriate length of time sufficient to prepare titanosilicate crystals, a portion of the synthesis mixture is transported through heat exchanger (FIG. 1, unit 3) for cooling purposes, and the cooled mixture is transported to a solids recovery unit (FIG. 1, unit 4) to separate and recover the titanosilicate crystals from the liquid phase of the synthesis mixture. The solids recovery unit may comprise one or a combination of filtration, centrifugation, or other separation device.

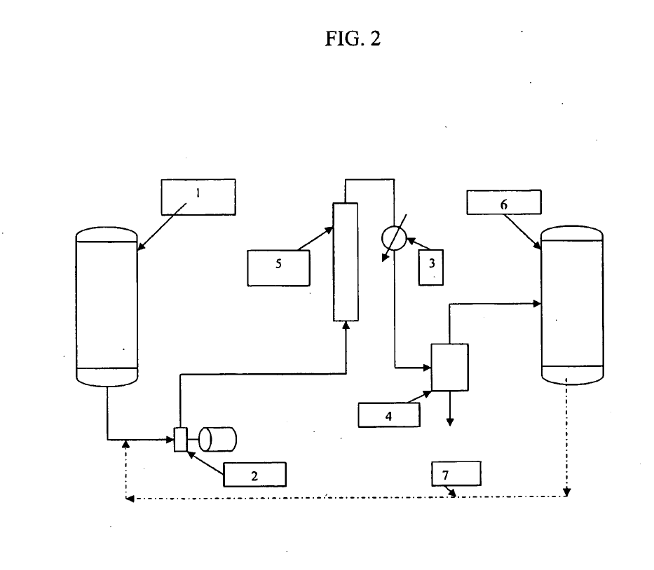

With reference to FIG. 2, a synthesis reaction process is illustrated for manufacturing the titanosilicate continuously using microwave radiation crystallization. In the illustrated embodiment a reactor vessel (FIG. 2, unit 1) is continuously loaded with a synthesis reaction mixture comprising water, a source of titanium, a source of silicon, and a structure-directing agent or template. The reaction mixture is circulated from the reactor vessel to a microwave source unit (FIG. 2, unit 5) by means of circulating pump (FIG. 1, unit 2). After leaving the microwave source unit, the synthesis mixture is pumped through heat exchanger (FIG. 2, unit 3) to cool the mixture; and then, the cooled mixture is transported to a solids recovery unit (FIG. 2, unit 4) to separate and recover the titanosilicate crystals from the liquid phase of the synthesis mixture. The separated liquid phase is transported into spent liquid tank (FIG. 2, unit 6); and optionally, liquid phase is recycled via conduit (FIG. 2, line 7) back to synthesis reactor (FIG. 2, unit 1).

Advantageously, the titanosilicate obtained by microwave heating provides for a hydro-oxidation catalyst that produces at least comparable results in hydro-oxidation processes as compared with conventional hydro-oxidation catalysts using a titanosilicate prepared by hydro-thermal methods. Beneficially, the titanosilicate prepared by microwave heating provides for a hydro-oxidation catalyst that exhibits improved performance as compared with a conventionally-prepared hydro-oxidation catalyst.

The loading of catalytic metals onto the titanosilicate can vary, provided that the resulting catalyst is active in a hydro-oxidation process. Generally, the total loading of catalytic metals is greater than about 0.001 weight percent, based on the total weight of catalytic metal(s) and titanosilicate. Preferably, the total loading is greater than about 0.003, more preferably, greater than about 0.005 weight percent, and most preferably, greater than about 0.01 weight percent. Generally, the total loading is less than about 20 weight percent. Preferably, the total metal loading is less than about 10.0, more preferably, less than about 5.0 weight percent, and most preferably, less than about 1.0 weight percent, based on total weight of catalytic metals(s) and titanosilicate.

The catalytic metal component(s) can be deposited onto the titanosilicate by any method known in the art that provides for an active and selective catalyst. Non-limiting examples of known deposition methods include impregnation, ion-exchange, deposition-precipitation, spray-drying, vapor deposition, and solid-solid reaction. A deposition-precipitation method is disclosed by S. Tsubota, M. Haruta, T. Kobayashi, A. Ueda, and Y. Nakahara, “Preparation of Highly Dispersed Gold on Titanium and Magnesium Oxide,” in Preparation of Catalysts V, G. Poncelet, P. A. Jacobs, P. Grange, and B. Delmon, eds., Elsevier Science Publishers B. V., Amsterdam, 1991, p. 695ff, incorporated herein by reference. A preferred impregnation method is disclosed in WO 00/59633, incorporated herein by reference. Other deposition methods are also disclosed in the art.

Optionally, the catalyst of this invention can beneficially comprise one or more promoter metals. Promoter metals for hydro-oxidation processes are known in the art, as described, for example, in WO 98/00414, incorporated herein by reference. Preferably, the promoter metal is selected from Group 1 metals of the Periodic Table including lithium, sodium, potassium, rubidium, and cesium; Group 2 metals including beryllium, magnesium, calcium, strontium, and barium; lanthanide rare earth metals including lanthanum, cerium, praseodymium, neodymium, promethium, samarium, europium, gadolinium, terbium, dysprosium, holmium, erbium, thulium, ytterbium, and lutetium; and the actinides, specifically, thorium and uranium. Preferably, the promoter metal is selected from lithium, sodium, potassium, rubidium, cesium, magnesium, calcium, barium, erbium, lutetium; and mixtures thereof. The lanthanides may be considered to function as the catalytic metal when gold and silver are absent (for example, La/Na) or considered to function more in the capacity of a promoter metal when gold or silver is present (for example, Au/La).

If one or more promoter metals are used, then the total quantity of promoter metal(s) generally is greater than about 0.001, preferably, greater than about 0.010, and more preferably, greater than about 0.1 weight percent, based on the total weight of the catalyst. The total quantity of promoter metal(s) is generally less than about 20, preferably, less than about 15, and more preferably, less than about 10 weight percent, based on the total weight of the catalyst. The prior art adequately describes the deposition of promoter metals onto the titanosilicate. Refer to WO 98/00414, incorporated herein by reference.

In addition to promoter metals, the catalyst of this invention may also contain promoting anions, including for example, halide, carbonate, phosphate, and carboxylic acid anions, such as acetate, maleate, and lactate. Such promoting anions are known in the art, as described in WO 00/59632, incorporated herein by reference.

Generally, the composite, comprising one or more catalytic metals and, optionally, one or more promoter metals and/or promoting anions deposited on the titanosilicate is subjected to a drying under vacuum or under air at a temperature between 20° C. and about 120° C. Optionally, a final heating may be employed under air, or oxygen, or under a reducing atmosphere, such as hydrogen, or under an inert atmosphere, such as nitrogen, at a temperature sufficient to prepare the catalyst of this invention. If a final calcination is employed, then the composite is calcined under nitrogen, optionally containing oxygen. Preferably, the composite is calcined in an atmosphere of nitrogen containing from about 0 to about 30 percent oxygen, and preferably, from about 10 to about 25 percent oxygen, by volume. The calcination temperature beneficially is greater than about 450° C., preferably, greater than about 500° C., and more preferably greater than about 525° C. The calcination temperature beneficially is less than about 900° C., preferably, less than about 750° C., and more preferably, less than about 600° C. The heating rate from room temperature to the calcination temperature is typically greater than about 0.1° C./min, and preferably, greater than about 0.5° C./min, and more preferably, greater than about 1.5° C./min. The heating rate from room temperature to the calcination temperature is typically less than about 20° C./min, preferably, less than about 15° C./min, and more preferably, less than about 10° C./min. At the calcination temperature, the hold time is typically greater than about 2 hours, preferably greater than about 5 hours, and more preferably greater than about 8 hours, while the hold time is typically less than about 20 hours, preferably, less than about 15 hours, and more preferably, less than about 12 hours.

Optionally, the catalyst of this invention can be extruded with, bound to, or supported on a second support, such as silica, alumina, aluminosilicate, magnesia, titania, carbon, or mixtures thereof. The second support may function to improve the physical properties of the catalyst, such as, its strength or attrition resistance, or to bind the catalyst particles together. Generally, the quantity of second support ranges from about 0 to about 95 weight percent, based on the combined weight of catalyst and second support

The process conditions for the hydro-oxidation process of this invention are known in the art. Batch, fixed-bed, transport bed, fluidized bed, moving bed, trickle bed, and shell and tube reactors are all suitable reactor designs, as well as continuous and intermittent flow and swing reactors. Preferably, the process is conducted in a gas phase and the reactor is designed with heat transfer features for the removal of the heat produced. Preferred reactors designed for this purpose include fixed-bed, shell and tube, fluidized bed, and moving bed reactors, as well as swing reactors constructed from a plurality of catalyst beds connected in parallel and used in an alternating fashion.

The hydro-oxidation process is typically conducted at a temperature greater than ambient, taken as 20° C., preferably, greater than about 70° C., more preferably greater than about 100° C., and most preferably, greater than about 120° C. Usually, the process is conducted at a temperature preferably less than about 300° C., more preferably less than about 230° C., and most preferably, less than about 175° C. Typically, the pressure is greater than about atmospheric, preferably, greater than about 15 psig (205 kPa), and more preferably, greater than about 200 psig (1379 kPa). Typically, the pressure is less than about 600 psig (4137 kPa), preferably, less than about 400 psig (2758 kPa), and more preferably, less than about 325 psig (2241 kPa).

In flow reactors the residence time of the reactants and the molar ratio of reactants to catalyst will be determined by the space velocity. For a gas phase process the gas hourly space velocity (GHSV) of the hydrocarbon reactant can vary over a wide range, but typically is greater than, about 10 ml hydrocarbon per ml catalyst per hour (hr⁻¹), preferably greater than about 250 hr⁻¹, and more preferably, greater than about 1,400 hr⁻¹ Typically, the GHSV of the hydrocarbon reactant is less than about 50,000 hr⁻¹, preferably, less than about 35,000 hr⁻¹, and more preferably, less than about 20,000 hr⁻¹. Likewise, for a liquid phase process the weight hourly space velocity (WHSV) of the hydrocarbon reactant is typically greater than about 0.01 g hydrocarbon per g catalyst per hour (hr⁻¹), preferably, greater than about 0.05 hr⁻¹, and more preferably, greater than about 0.1 hr⁻¹. Typically, the WHSV of the hydrocarbon reactant is less than about 100 hr⁻¹, preferably, less than about 50 hr⁻¹, and more preferably, less than about 20 hr⁻¹. The gas and weight hourly space velocities of the oxygen, hydrogen, and optional diluent can be determined from the space velocity of the hydrocarbon by taking into account the relative molar ratios desired.

The conversion of hydrocarbon in the process of this invention can vary depending upon the specific process conditions employed, including the specific hydrocarbon, temperature, pressure, mole ratios, and form of the catalyst. As used herein, the term “conversion” is defined as the mole percentage of hydrocarbon that reacts to form products. Typically, a hydrocarbon conversion of greater than about 0.5 mole percent is achieved. Preferably, the hydrocarbon conversion is greater than about 1 mole percent, more preferably, greater than about 1.40 mole percent.

Likewise, the selectivity to partially-oxidized hydrocarbon can vary depending upon the specific process conditions employed. As used herein, the term “selectivity” is defined as the mole percentage of reacted hydrocarbon that forms a particular partially-oxidized hydrocarbon, preferably, an olefin oxide. The process of this invention produces partially-oxidized hydrocarbons, preferably olefin oxides, in unexpectedly high selectivity. Typically, the selectivity to partially-oxidized hydrocarbon is greater than about 70, preferably, greater than about 80, more preferably, greater than about 90 mole percent, and most preferably, greater than about 95 mole percent.

In the process of this invention, water is formed as a by-product of the partial-oxidation of hydrocarbon. Additional hydrogen may be burned directly to form water. Accordingly, it is desirable to minimize the formation of water as much as possible. In the oxidation of an olefin to an olefin oxide in this invention, the water/olefin oxide molar ratio is typically greater than about 1/1, but less than about 10/1, and preferably, less than about 4/1, and more preferably, less than about 2.5/1.

The invention will be further clarified by a consideration of the following examples, which are intended to be purely exemplary of the use of the invention. Other embodiments of the invention will be apparent to those skilled in the art from a consideration of this specification or practice of the invention as disclosed herein. Unless otherwise noted, all percentages are given on a weight percent basis.

### EXAMPLE 1

(a) A synthesis solution (1500 ml volume) was prepared containing tetraethylorthosilicate (TEOS, 540 ml), titanium tetra(n-butoxide) (11.6 ml), tetrapropylammonium hydroxide (40 percent in water, 442 ml), and water (506.4 ml). The reactants were charged into a 2 liter jacketed glass reactor equipped with overhead stirring and a circulating chiller. Following the addition of the TEOS, the titanium tetra(n-butoxide) was added incrementally over a five minute time period. The mixture was stirred for 5 minutes. The temperature of the solution at the end of the five minute period fell between 0° C. and −6° C., typically −4° C. The tetrapropylammonium hydroxide and water were added simultaneously over a one-hour time period. The circulator was turned off and the synthesis solution emulsified at room temperature overnight (˜16 hours) with stirring. The emulsified solution was clear and particulate free.

Approximately 70 ml of synthesis solution was placed in a microwave Teflon reactor vessel. The Teflon reactor was sealed according to manufacturer's recommendation and loaded into a microwave oven. A total of nine reactors were loaded in this manner. The thermocouple was inserted into one of the reactor vessels for temperature control. In addition, the same reactor was attached to the pressure transducer for pressure monitoring. The microwave was programmed to heat the reactors from room temperature to 160° C. over a 15-minute period. The reaction progress was monitored by observing the temperature and pressure plots on monitor. The temperature was maintained at 160° C. for 2 hours. Upon completion, the reactors were cooled to room temperature and removed from the oven.

(b) A second set of nine reactors was loaded with the synthesis solution and crystallized using the same protocol. These reactors, however, were held at 160° C. for 4 hours, then cooled and removed from the oven.

The microwave-produced crystals were recovered by high speed centrifugation at refrigerated conditions (˜5° C.). The mother liquor was removed and the crystals washed a total of four times with deionized water. The washed crystals were dried at 80° C., sieved and calcined for 10 hours at 550° C. in air atmosphere. Samples of the calcined crystals (finer than 30 mesh) were impregnated by incipient wetness technique using a methanol solution of sodium acetate and hydrogen tetrachloroaurate (III) trihydrate containing a 22:1 molar ratio of sodium acetate to gold, thereby resulting in a gold loading of 1600 ppm.

The resulting catalyst (2 g) was charged into a stainless steel tubular reactor (½ inch dia.×12 inches) (1.27 cm dia.×30.48 cm) for evaluation in a hydro-oxidation of propylene with oxygen in the presence of hydrogen to form propylene oxide. The performance evaluation protocol utilized a gas composition of 40 percent propylene, 10 percent oxygen, and 5 percent hydrogen, by volume, at a flow-rate of 1800 SCCM (standard cubic centimeters per minute). Reactor pressure was maintained at 300 psig (2,068 kPa). The reactor temperature was ramped slowly from 140° C. to 150° C. The initial performance data (30±10 minutes operation at 150° C.) are shown in Table 1 hereinbelow.

TABLE 1

| | | Percent | |
|---|---|---|---|
| | Percent | Selectivity | |
| Example | Conversion | to PO | H₂O/PO |
| 1(a) Microwave 160° C./2 h | 1.67 | 99.3 | 2.16 |
| 1(b) Microwave 160° C./4 h | 1.80 | 99.2 | 2.21 |
| CE-1 Conventional 160° C./4 days | 1.51 | 99.6 | 1.93 |

From Table 1 it is seen that a catalyst comprising gold on a titanosilicate, wherein the titanosilicate is prepared by microwave heating, exhibits good activity and excellent selectivity in the hydro-oxidation of propylene to propylene oxide.

### Comparative Experiment 1 (CE-1)

Example 1 was repeated with the exception that the titanosilicate synthesis solution was placed in stainless steel cylinder and heated at 160° C. in a conventional oven for 4 days. Titanosilicate crystals were recovered in the same manner as described in Example 1. A gold on titanosilicate catalyst was prepared and evaluated in the manner described in Example 1, with the exception that the titanosilicate was prepared by conventional heating rather than by microwave heating. Results are shown in Table 1.

When Comparative Experiment 1 is compared with Example 1, it is seen that the activity of the catalyst prepared using microwave heating is higher, by a factor of about 10 to 20 percent, than the activity of the catalyst prepared by conventional heating. Moreover, the propylene oxide selectivity of the microwaved catalyst is comparable to the selectivity of the conventional catalyst; both selectivities are high. The conventional catalyst produced somewhat less water by-product, but the quantity of water obtained with the microwaved catalyst is acceptable.

### EXAMPLE 2

A second synthesis solution (750 ml) was prepared in the same manner as described in Example 1 with the following reactant composition: tetraethylorthosilicate (TEOS, 238 ml), titanium tetra(n-butoxide) (2.5 ml), tetrapropylammonium hydroxide (40 percent in water, 87 ml), and water (422.5 ml). Again the emulsified solution after 16 hours at room temperature was clear and particulate free.

A set of nine reactors was loaded for microwave crystallization as previously described in Example 1. The microwave was programmed to heat the reactors from room temperature to 175° C. over a 15-minute period. The reaction progress was monitored by observing the temperature and pressure plots on monitor. The temperature was maintained for 2 hours. Upon completion, the reactors were cooled to room temperature and removed from the oven.

The titanosilicate crystals prepared by microwave heating were recovered and washed in the manner described in Example 1. A catalyst comprising gold on the microwaved titanosilicate was prepared and evaluated in the hydro-oxidation of propylene to propylene oxide, also in the manner described in Example 1. The initial performance data (30±10 minutes operation at 150° C.) are shown in Table 2 hereinbelow.

TABLE 2

| | | Percent | |
|---|---|---|---|
| | Percent | Selectivity | |
| Example | Conversion | to PO | H₂O/PO |
| 2 - Microwave 175° C./2 h | 1.69 | 99.3 | 1.91 |
| CE-2 - Conventional 160° C./4 days | 1.46 | 99.3 | 2.11 |

From Table 2 it is seen that a catalyst comprising gold on a titanosilicate, wherein the titanosilicate is prepared by microwave heating, exhibits good activity and excellent selectivity in the hydro-oxidation of propylene to propylene oxide.

### Comparative Experiment 2 (CE-2)

A large batch of titanosilicate synthesis solution was prepared using the same formulation as Example 2. This material was crystallized in a conventional 30 gallon stainless steel reactor heated at 160° C. for 4 days. Titanosilicate crystals were recovered and calcined. A gold on titanosilicate catalyst was prepared and evaluated in the same manner as Example 2. Results are shown in Table 2.

When Comparative Experiment 2 is compared with Example 2, it is seen that the activity of catalyst prepared using microwave heating is higher, by a factor of about 16 percent, than the activity of the catalyst prepared by conventional heating. Moreover, the propylene oxide selectivity of the microwaved catalyst is comparable to the selectivity of the conventional catalyst; both are very high. The microwaved catalyst produces somewhat less water by-product.

1. A hydro-oxidation process comprising contacting a hydrocarbon with oxygen in the presence of hydrogen and a hydro-oxidation catalyst comprising one or more catalytic metals selected from gold, silver, the platinum group metals, the lanthanide rare earth metals, and mixtures thereof, deposited on a titanosilicate, under contacting conditions sufficient to prepare a partially-oxidized hydrocarbon; the titanosilicate being characterized in that it is prepared by microwave heating.

2. The process of claim 1 wherein the hydrocarbon is a C₁₋₂₀ alkane or a C₂₋₂₀ olefin.

3. The process of claim 1 wherein the catalytic metal is gold or gold in combination one or more metals selected from the group consisting of silver, the platinum group metals, the lanthanide rare earth metals, and combinations thereof.

4. The process of claim 1 wherein the catalytic metal is present in an amount greater than about 0.001 and less than about 20 weight percent, based on the total weight of catalytic metal(s) and titanosilicate.

5. The process of claim 1 wherein the catalyst further comprises one or more promoter metals selected from Group 1, Group 2, the lanthanide rare earths, and the actinide metals of the Periodic Table, and mixtures thereof; and optionally, one or more promoter anions selected from the group consisting of halide, carbonate, phosphate, carboxylic acid anions, and mixtures thereof, and further wherein the one or more promoter metals are present in the catalyst in a total amount greater than about 0.001 to less than about 20 weight percent, based on the total weight of the catalyst,

6. The process of claim 1 wherein the catalyst further comprises one or more promoter metals selected from the group consisting of lithium, sodium, potassium, rubidium, cesium, magnesium, calcium, barium, erbium, lutetium, and mixtures thereof.

7. The process of claim 1 wherein the titanosilicate is selected from crystalline, quasi-crystalline, and amorphous titanosilicates having a Si/Ti atomic ratio ranging from about 5/1 to about 20,000/1.

8. The process of claim 1 wherein the titanosilicate is selected from the group consisting of TS-1, TS-2, Ti-beta, Ti-ZSM-5, Ti-ZSM-12, Ti-ZSM-48, Ti-MCM-41, Ti-MCM-48, and titanosilicates of the SMA family.

9. The process of claim 1 wherein the catalyst is prepared by (a) heating by microwave radiation a synthesis solution comprising a source of titanium, a source of silicon, a structure directing agent (or template), and water, under conditions sufficient to prepare the titanosilicate; (b) recovering the titanosilicate from the synthesis solution, and calcining the titanosilicate wider oxygen or air to remove the structure directing agent (or template); (c) depositing one or more catalytic metals onto the titanosilicate; and optionally, (d) heating the resulting catalytic metal(s)-titanosilicate composite under oxygen, or under a reducing agent, or under an inert gas, under conditions sufficient to prepare the catalyst.

10. The process of claim 9 wherein the source of titanium is selected from the group consisting of titanium tetra(alkoxides), titanium tetra(halides), titanium oxyhalides, and mixtures thereof.

11. The process of claim 9 wherein the source of titanium is selected from the group consisting of titanium tetra(ethoxide), titanium tetra(iso-propoxide), titanium tetra(n-butoxide), titanium tetrafluoride, titanium tetrachloride, titanium oxychloride, and mixtures thereof.

12. The process of claim 9 wherein the source of silicon is selected from the group consisting of tetraalkylorthosilicates and fumed or precipitated silicas.

13. The process of claim 9 wherein the template or structure-directing agent is selected from trialkylamines, tetraalkylammonium hydroxides, tetraalkylammonium halides, and mixtures thereof.

14. The process of claim 9 wherein the titanosilicate is prepared from a synthesis solution comprising on a molar basis: a SiO₂/TiO₂ ratio in the range of about 5 to about 20,000; a ratio of SiO₂ to structure directing agent in the range of about 1.7 to about 8.3; and a SiO₂/H₂O ratio in the range of about 0.005 to about 0.49.
about

15. The process of claim 9 wherein the microwave heating is provided by a microwave generator having an energy input from about 100 watts to about 6,000 watts per liter of synthesis solution, and wherein the microwave heating is conducted at a heating rate greater than about 0.5° C./min and less than about 40° C./min.

16. The process of claim 9 wherein the microwave heating is conducted in two stages, at a first temperature greater than about 80° C. and less than about 150° C. for a first temperature hold time greater than about 0 min and less than about 120 min, and at a final temperature greater than about 140° C. and less than about 250° C. for a final temperature hold time greater than about 3 minutes and less than about 16 hours.

17. The process of claim 9 wherein the microwave heating is conducted in one stage at a final temperature greater than about 140° C. and less than about 250° C. for a final temperature hold time greater than about 3 minutes and less than about 16 hours.

18. The process of claim 1 wherein the titanosilicate product prepared by microwave heating has an average crystal size larger than about 0.01 micron and smaller than about 5 microns in diameter (or critical cross-sectional dimension for non-spherical particles).

19. The process of claim 1 wherein the hydro-oxidation is conducted at a temperature greater than about 20° C. and less than about 300° C., and at a pressure greater than about 15 psig and less than about 600 psig, and optionally, in the presence of a diluent selected from the group consisting of helium, nitrogen, propane, methane, argon, carbon dioxide, steam, and mixtures thereof.

20. The process of claim 1 wherein the hydrocarbon is an olefin; the olefin conversion is greater than about 0.5 mole percent, and the selectivity to olefin oxide is 25 greater than about 70 mole percent; and optionally, wherein hydrogen is used in an efficiency measured by a water to olefin oxide molar ratio of less than about 10/1.

21. The process of claim 1 wherein propylene is hydro-oxidized to propylene oxide, and the titanosilicate is prepared by a process comprising:
(a) heating by microwave radiation a synthesis solution comprising tetraethylorthosilicate, titanium tetra(n-butoxide), tetrapropylammonium hydroxide, and water, under conditions wherein a microwave generator provides an energy input of from greater than about 100 watts to less than about 6,000 watts per liter of synthesis solution; and the microwave heating is conducted at a heating rate greater than about 0.5° C./min and less than about 40° C./min in one stage at a final temperature greater than about 140° C. and less than about 250° C. for a final temperature hold time greater than about 3 minutes and less than about 16 hours, to prepare a titanosilicate TS-1;
(b) recovering the titanosilicate TS-1 from the synthesis solution by filtration, centrifugation, or flocculation followed by filtration or centrifugation; and
(c) calcining the recovered titanosilicate to remove tetrapropylammonium hydroxide.

22. A hydro-oxidation catalyst composition comprising one or more catalytic metals selected from gold, silver, the platinum group metals, the lanthanide rare earth metals, and mixtures thereof, deposited on a titanosilicate, characterized in that the titanosilicate is prepared by microwave heating.

23. The catalyst composition of claim 22 wherein the catalytic metal is gold or gold in combination with silver, one or more platinum group metals, one or more lanthanide rare earth metals, or mixtures thereof; and wherein optionally, the catalytic metal is present in an amount greater than about 0.001 and less than about 20 weight percent, based on the total weight of catalytic metal(s) and titanosilicate.

24. The catalyst composition of claim 22 wherein the catalyst further comprises one or more promoter metals selected from Group 1, Group 2, the lanthanide rare earth metals, and the actinide metals of the Periodic Table, and mixtures thereof; and optionally, wherein the catalyst further comprises one or more promoter anions selected from the group consisting of halide, carbonate, phosphate, carboxylic acid anions, and mixtures thereof; and further wherein the one or more promoter metals are present in the catalyst in a total amount greater than about 0.001 to about 20 weight percent, based on the total weight of the catalyst,

25. The catalyst composition of claim 24 wherein the one or more promoter metals are selected from the group consisting of lithium, sodium, potassium, rubidium, cesium, magnesium, calcium, barium, erbium, lutetium, and mixtures thereof.

26. The catalyst composition of claim 22 wherein the titanosilicate is selected from crystalline, quasi-crystalline, and amorphous titanosilicates having a Si/Ti atomic ratio ranging from about 5/1 to about 20,000/1.

27. The catalyst composition of claim 22 wherein the titanosilicate is selected from the group consisting of TS-1, TS-2, Ti-beta, Ti-ZSM-5, Ti-ZSM-12, Ti-ZSM-48, and Ti-MCM-41, Ti-MCM-48, and titanosilicates of the SMA family.

28. The catalyst composition of claim 22 wherein the catalyst is supported on a second support selected from the group consisting of silicas, aluminas, aluminosilicates, magnesias, titanias, carbon, and mixtures thereof.

29. The catalyst composition of claim 22 wherein the titanosilicate is prepared by (a) microwave heating a synthesis solution comprising a source of titanium, a source of silicon, a template or structure directing agent, and water; and (b) recovering the titanosilicate from the synthesis solution, and calcining the recovered titanosilicate under conditions sufficient to remove the structure directing agent (or template).

30. The catalyst composition of claim 29 wherein the source of titanium is selected from the group consisting of titanium tetra(alkoxides), titanium tetrahalides, titanium oxyhalides, and mixtures thereof; and wherein the source of silicon is selected from the group-consisting of tetraalkylorthosilicates and fumed or precipitated silicas; and wherein the template or structure-directing agent is selected from tri(alkyl)amines, tetra(alkyl)ammonium hydroxides, and tetra(alkyl)ammonium halides.

31. The catalyst composition of claim 29 wherein the titanosilicate is prepared by microwave heating a synthesis solution comprising a source of silicon, a source of titanium, a structure directing agent (or template), and water, on a molar basis: a SiO₂/TiO₂ ratio in the range of about 5 to about 20,000; a ratio of SiO₂ to structure-directing agent in the range of about 1.7 to about 8.3; and a SiO₂/H₂O ratio in the range of about 0.005 to about 0.49.

32. The catalyst composition of claim 22 wherein the microwave heating is provided by a microwave generator having an energy input of from about 100 watts to about 6,000 watts per liter of synthesis solution, and wherein the microwave heating is conducted at a heating rate greater than about 0.5° C./min and less than about 40° C./min.

33. The catalyst composition of claim 22 wherein the microwave heating is conducted in two stages, by ramping to a first temperature greater than about 80° C. and less than about 150° C. for a first temperature hold time greater than about 0 min and less than about 120 min, and then ramping to a final temperature greater than about 140° C. and less than about 250° C. for a final temperature hold time greater than about 3 minutes and less than about 16 hours.

34. The catalyst composition of claim 22 wherein the microwave heating is conducted by ramping to one final temperature greater than about 140° C. and less than about 250° C. for a final temperature hold time greater than about 3 minutes and less than about 16 hours.

35. The catalyst composition of claim 22 wherein the titanosilicate product prepared by microwave heating has an average crystal size larger than about 0.01 micron and smaller than about 5 microns in diameter (or critical cross-sectional dimension for non-spherical particles).

36. The catalyst composition of claim 22 wherein the titanosilicate is prepared by a process comprising:
(a) heating by microwave radiation a synthesis solution comprising tetraethylorthosilicate, titanium tetra(n-butoxide), tetrapropylammonium hydroxide, and water under conditions wherein a microwave generator has an energy input of from about 100 watts to about 6,000 watts per liter of synthesis solution; and the microwave heating is conducted at a heating rate greater than about 0.5° C./min and less than about 40° C./min in one stage at a final temperature greater than about 140° C. and less than about 250° C. for a final temperature hold time greater than about 3 minutes and less than about 16 hours, to prepare a titanosilicate TS-1;
(b) recovering the titanosilicate TS-1 from the synthesis solution by filtration, centrifugation, or flocculation followed by filtration or centrifugation; and
(c) calcining the titanosilicate thus recovered to remove the structure directing agent (or template).

37. A method of preparing a hydro-oxidation catalyst composition comprising:
(a) heating by microwave radiation a synthesis solution comprising a source of titanium, a source of silicon, a structure directing agent (or template), and water, under conditions sufficient to prepare a titanosilicate;
(b) recovering the titanosilicate from the synthesis solution, and calcining the titanosilicate under conditions sufficient to remove the structure directing agent (or template);
(c) depositing a catalytic metal onto the titanosilicate, the catalytic metal being selected from gold, silver, one or more platinum group metals, one or more lanthanide rare earth metals, and mixtures thereof, to form a metal-titanosilicate composite; and
(d) optionally, heating the metal-titanosilicate composite under an oxygen-containing gas or under a reducing atmosphere or under an inert gas, under conditions sufficient to prepare the hydro-oxidation catalyst.
